(19) United States
(12) Patent Application Publication
(10) Pub. No.: US 2026/0119612 A1
(43) Pub. Date: Apr. 30, 2026

(54) ACCURACY EVALUATION AND SELECTIVE FEEDBACK CONTROL FOR PROMPT PROCESSING UNITS AT INFERENCE TIME

(71) Applicant: Cisco Technology, Inc., San Jose, CA (US)

(72) Inventors: Majed El Helou, Lausanne (CH); Chiara Troiani, Cheseaux-sur-Lausanne (CH); Jean Andrei Diaconu, Gaillard (FR); Hervé Muyal, Gland (CH); Marcelo Yannuzzi, Nuvilly (CH)

(73) Assignee: Cisco Technology, Inc., San Jose, CA (US)

(21) Appl. No.: 19/039,596

(22) Filed: Jan. 28, 2025

Related U.S. Application Data
(60) Provisional application No. 63/712,795, filed on Oct. 28, 2024.

(51) Int. Cl. G06F 18/2415; G06F 40/40

(52) U.S. Cl. CPC G06F 18/2415; G06F 40/40

(57) ABSTRACT

In one implementation, a device may classify a prompt from a user to a language model by a first prompt classifier and a second prompt classifier in parallel at inference time by the language model. The device may evaluate, based on a classification of the prompt by the first prompt classifier and a classification of the prompt by the second prompt classifier, an accuracy of the classification of the prompt by the first prompt classifier. The device may determine, based on the accuracy, whether feedback from the user on the classification of the prompt by the first prompt classifier is required. The device may cause, and responsive to a determination that the feedback is required, a solicitation for the feedback to be provided to the user.

### RELATED APPLICATION

This application claims priority to U.S. Prov. Appl. Ser. No. 63/712,795, filed Oct. 28, 2024, for ACCURACY EVALUATION AND SELECTIVE FEEDBACK CONTROL FOR PROMPT PROCESSING UNITS AT INFERENCE TIME, by El Helou, et al., the contents of which are incorporated herein by reference.

### TECHNICAL FIELD

The present disclosure relates generally to computer networks, and, more particularly, to accuracy evaluation and selective feedback control for prompt processing units at inference time.

### BACKGROUND

The use of generative artificial intelligence (GenAI) is helping companies to gradually augment their productivity. For instance, sales, marketing, data analytics, or engineering departments are all increasingly utilizing GenAI, either through pre-trained Large Language Models (LLMs) and/or fine-tuned models and agents.

A first step toward assessing the productivity gains in the use of GenAI is to understand and classify the type of tasks that employees request LLMs and/or agents to perform. In order to accurately extract those insights, the detections and classifications thereof must be continuously evaluated so that they can be improved over time. Indeed, discrepancies in the detections and/or the classifications may be due to various different reasons, such as potential drifts in the distribution of the input data across classes, data drifts between the training and inference datasets, and/or the performance limitations of the model itself.

However, continuously evaluating the performance of a GenAI system is challenging. This is because many entities do not allow for the storage of prompts over time. In addition, while feedback from users can be valuable information, asking users for feedback can increase processing times and lead to user fatigue.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for sending prompts to a remote language model;

FIG. 4 illustrates an example of an architecture utilizing prompt processing units;

FIG. 5 illustrates an example of an evaluation process to facilitate continuous evaluation at inference time of the accuracy of the detections and classifications performed by a prompt processing unit;

FIG. 6 illustrates an example of system for concurrently training primary and secondary prompt processing unit classifiers on the same training data set;

FIG. 7 illustrates an example of a system for implementing a confidence prediction procedure at inference time; and

FIG. 8 illustrates an example of a simplified procedure for accuracy evaluation and selective feedback control for prompt processing units at inference time, in accordance with one or more implementations described herein.

### DESCRIPTION OF EXAMPLE IMPLEMENTATIONS

### Overview

According to one or more implementations of the disclosure, a device may classify a prompt from a user to a language model by a first prompt classifier and a second prompt classifier in parallel at inference time by the language model. The device may evaluate, based on a classification of the prompt by the first prompt classifier and a classification of the prompt by the second prompt classifier, an accuracy of the classification of the prompt by the first prompt classifier. The device may determine, based on the accuracy, whether feedback from the user on the classification of the prompt by the first prompt classifier is required. The device may cause, and responsive to a determination that the feedback is required, a solicitation for the feedback to be provided to the user.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

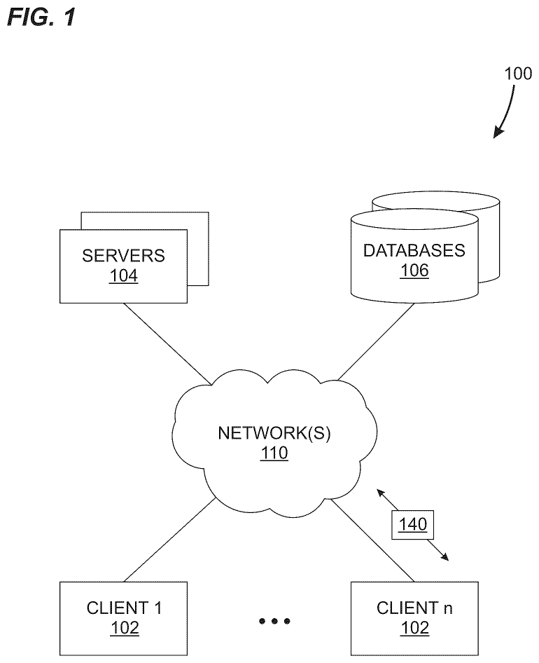

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

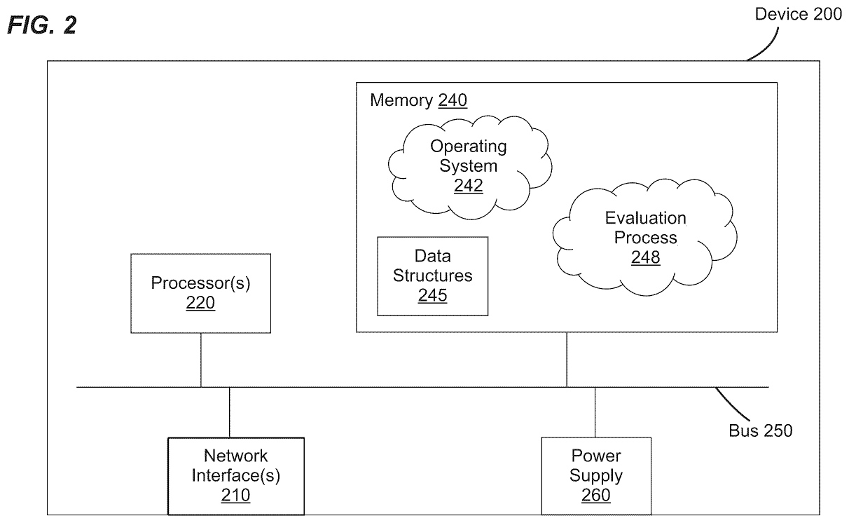

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, an evaluation process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, evaluation process 248 may include computer executable instructions that, when executed by processor(s) 220, cause device 200 to perform the techniques described herein. For example, evaluation process 248 may include computer-executable instructions stored on a computer-readable medium that are executable by processor(s) 220 to cause node/device 200 to perform a portion of an accuracy evaluation and selective feedback control operation for prompt processing units at inference time.

To do so, in some implementations, evaluation process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, evaluation process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that evaluation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, evaluation process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, evaluation process 248 may use a generative model to generate synthetic network traffic based on existing user traffic to test how the network reacts. Example generative approaches can include, but are not limited to, generative adversarial networks (GANs), foundation models such as large language models (LLMs), other transformer models, and the like.

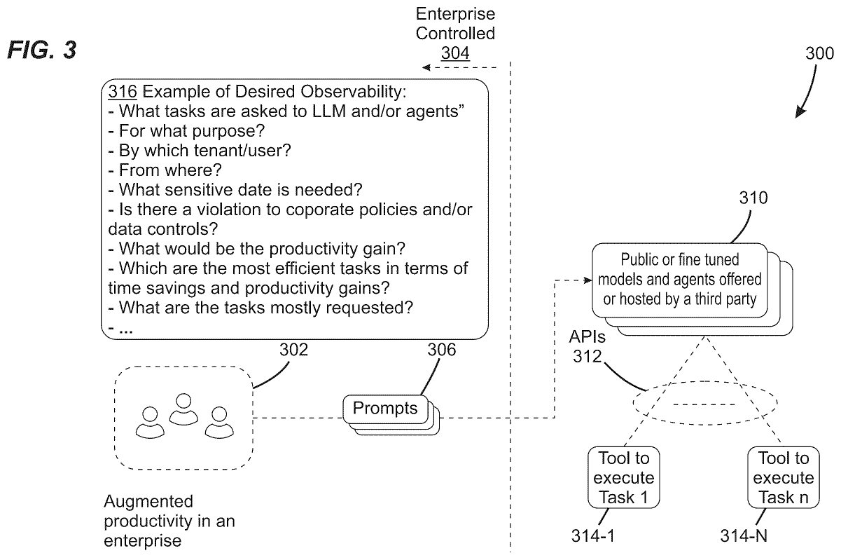

FIG. 3 illustrates an example of an architecture 300 for sending prompts to a remote language model, in various implementations. In architecture 300, users 302 in an enterprise-controlled network may send prompts 306 (e.g., queries, etc.) to an external machine learning model (e.g., machine learning model 310). Typically, prompts 306 may be generated based on input directly from users 302, such as via a chatbot assistant. However, further implementations provide for the use of other programmatic approaches to generate prompts 306, such as by a user selecting a button within a user interface and the underlying program generating a prompt, or the like. In some instances, the executing program may send prompts 306 to machine learning model 310 via one or more application programming interfaces (APIs) and present the results to users 302, accordingly.

Machine learning model 310 may be a public or finetuned language model, such as an LLM, or any other generative AI model configured to process the prompts 306. For example, users 302 such as sales, marketing, customer support, data analytics, engineering, product management, or other personnel in the enterprise may utilize prompts 306 to enhance their productivity.

Although many enterprises aim to leverage generative AI, they may also want to observe what tasks are requested by prompts 306 for performance by machine learning model 310. Additionally, users may want to observe and understand the effectiveness of machine learning model 310 in completing the requested tasks as well as what data is sent, used, and returned by these third-party systems. Consequently, while the prompts 306, users 302, and any corresponding API calls that they may make may be within the enterprise-controlled portion 304, an enterprise may wish to capture observability features 316 to enable more sophisticated controls over the sending of prompts 306 outside the enterprise.

For example, observability features 316 may include the capacity to detect and observe what tasks are requested to external models and/or agents, what sensitive data is needed, or what would be the productivity gain if the task is successfully completed by machine learning model 310. These and other observability features may be enabled, and facilitated, by the disclosed techniques using prompt processing units (PPUs). In addition, tools 314 (e.g., 314-1 . . . 314-N) for executing various tasks may be communicatively coupled (e.g., via APIs 312) to the machine learning model 310 and/or may be operable to participate in the execution of tasks specified in prompts 306.

While many online machine learning models (e.g., ChatGPT, etc.) today are able to interpret open-ended prompts and act upon them by generating artifacts based on such understanding, this skill is also not accessible to the enterprise itself (e.g., within the enterprise-controlled portion 304). This lack of skill hinders the ability to observe and understand the tasks requested by users 302, or what sensitive data would be involved to complete such tasks, and thus, the ability to apply effective controls before prompts 306 are sent to an external entity from that of the enterprise.

However, these features may be enabled, and facilitated, within architecture 300 using prompt processing units (PPUs). Hence, architecture 300 may be modified by incorporating an observability system that leverages the PPUs. For example, the PPUs may parse a query and/or detect a set of key features from prompts 306 in a systematic manner. The observability system may then leverage these characterizations to allow for sophisticated controls based on prompt observability and estimated productivity gains.

### Prompt Observability and Estimated Productivity Gain Insights Using Prompt Processing Units

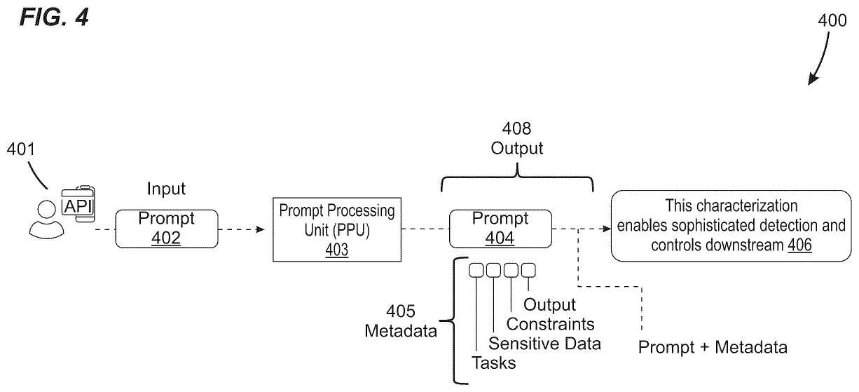

FIG. 4 illustrates an example of an architecture 400 utilizing PPUs, according to various implementations. In some instances, architecture 400 may be a portion of a data control system that leverages the outputs of PPUs to institute downstream data controls and/or facilitate the provision of prompt observability and estimated productivity gain.

As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query. For instance, PPU 403 may detect key features within the prompt 402 such as the tasks requested (e.g., “Coding Support”, “Content Processing”, or “Text Translation”), the data entailed to complete the tasks, any constraints applicable to complete the tasks, and/or the desired output upon completion of such tasks.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

A first step toward assessing the productivity gains in the use of GenAI is to understand and classify the type of tasks that employees request LLMs and/or agents to perform. The PPU may facilitate such an “understanding.” Again, the PPU may detect and distill a set of key features from the query carried in a prompt, such as the class of tasks requested to an LLM (e.g., “Coding Support”, “Content Processing”, or “Text Translation”), the data entailed to complete the tasks, any constraints applicable to carry out the tasks, and/or the desired output upon completion of such tasks from a prompt received as an input (e.g., from a user chat interface or an API).

In order to accurately extract those insights, the detections and classifications performed by PPUs may need to be continuously evaluated so that they can be improved over time. For instance, once a PPU starts to be used by an enterprise it may be important to get trustworthy answers to the following questions: “Was the main task carried in the prompt correctly detected and classified by the PPU?” “Were there any misdetections or misclassifications for the prompt?” “If so, which ones?”

Indeed, discrepancies in the detections and/or the classifications performed by a PPU may be due to different reasons. For example, such discrepancies may be due to potential drifts in the input data distribution across classes or across content between the training and inference stages and/or the inherent inaccuracy and limitations of machine learning models used within a PPU.

However, the continuous evaluation of a PPU poses complex challenges in practice. First, most companies won't allow solution providers to store and use their prompts for evaluation and/or training purposes. Only metadata is usually stored and available to solution providers. Second, this loss of information makes not only impossible to revisit and assess the detections and predictions made by a PPU later on (e.g., using post-processing techniques) but also forces the assessment and feedback mechanisms to occur concurrently at inference time (i.e., while the prompts traverse the system that contains the PPU). Third, requesting user feedback too often is not viable, since this will not only increase the delay for processing the prompts but also lead to user fatigue, thus making the feedback obtained less reliable over time—in fact, users usually have no incentive to provide such feedback. Moreover, existing techniques to sample and drastically reduce the feedback required from users are either not applicable or inefficient in the context of the detections and classifications performed by PPUs. For example, there is a void in techniques dealing with feedback for textual prompts in enterprise environments using GenAI, especially, when the detections and collection of feedback are constrained to happen at inference time.

Overall, existing techniques fall short in effectively assessing the accuracy of the detections and predictions made by a PPU at inference time, and selectively enabling the input of feedback while: i) dramatically reducing the users' fatigue; ii) incentivizing users to provide trustworthy feedback; and iii) learning from misdetections and/or misclassifications delivered by PPUs. As a result, PPUs currently operate in open loop. That is, PPUs have neither supplementary means supporting online evaluations in their current deployments nor means enabling the input of user feedback.

### Accuracy Evaluation and Selective Feedback Control for Prompt Processing Units at Inference Time

In contrast, the techniques described herein overcome these challenges by introducing a mechanism that facilitates continuous evaluation of the accuracy of the detections and classifications performed by a PPU directly at inference time. The techniques introduced herein may provide confidence prediction mechanisms coupled with an adaptive response and incentive method designed to selectively request and collect user feedback. The feedback received at inference time may even be used to override the original detection made by a PPU. As outlined above, the techniques described herein may be applied concurrently at inference time, thereby requiring neither the storage of user prompts nor their subsequent processing.

Specifically, according to various implementations, a device may classify a prompt from a user to a language model by a first prompt classifier and a second prompt classifier in parallel at inference time by the language model. The device may evaluate, based on a classification of the prompt by the first prompt classifier and a classification of the prompt by the second prompt classifier, an accuracy of the classification of the prompt by the first prompt classifier. The device may determine, based on the accuracy, whether feedback from the user on the classification of the prompt by the first prompt classifier is required. The device may cause, and responsive to a determination that the feedback is required, a solicitation for the feedback to be provided to the user.

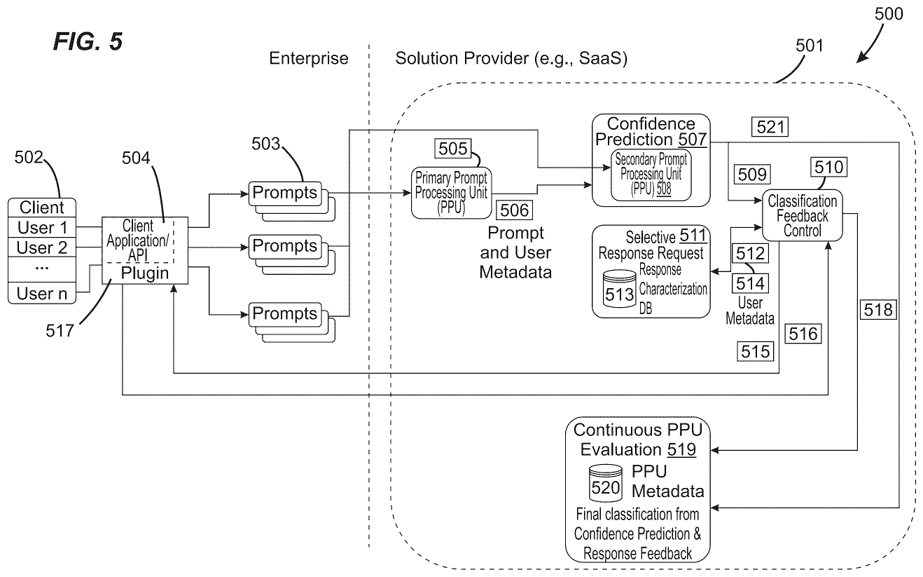

Operationally, FIG. 5 illustrates an example of a system 500 including an evaluation process 501 configured to facilitate continuous evaluation at inference time of the accuracy of the detections and classifications performed by a PPU.

The techniques detailed herein may operate on a prompt-by-prompt basis and may provide a confidence prediction mechanism supported by a secondary PPU 508, working in concert with an adaptive response and incentive method designed to selectively request and collect user feedback. The feedback received may be used to override the original detections made by the primary PPU 505, if, and only if, the likelihood of a misdetection and/or misclassification by the primary PPU is high.

In various implementations, the system 500 may facilitate the continuous evaluation of PPUs directly on the “hot path”, i.e., without the need to store and subsequently process the users' prompts. The system 500 may dramatically reduce the number of prompts for which feedback might be required, thereby reducing users' fatigue. Further, the system 500 may facilitate the use of the metadata collected to detect drifts from the baseline behavior and/or enhance the accuracy of a PPU.

In system 500, a client 502 (e.g., a tenant in system 500), which may include multiple users (e.g., User 1, User2, up to User n). Each of these users may generate prompts 503 that may be sent to external language models (e.g., LLMs) and/or agents that are not depicted in FIG. 5.

Prompts 503 may be generated in an enterprise-controlled environment, for example using a client application and/or an API 504. Prompts 503 may be either intercepted or replicated and sent to a primary PPU 505, which may be reachable as part of a SaaS deployment provisioned by a solution provider, or alternatively, as an on-premises deployment, or as part of a Virtual Private Cloud (VPC) deployment. For instance, multiple ways to intercept and transparently create copies of prompts 503 may be utilized, including plugins such as for various communication platforms (e.g., WebEx, Slack, and Kong), SDKs providing wrappers around widely used libraries (e.g., Python SDKs for machine learning and AI libraries like OpenAI, Azure OpenAI, Langchain), as well as JavaScript libraries (e.g., npm libraries for React). Once prompts 503 are obtained (e.g., using any of the aforementioned means), they might be forwarded to primary PPU 505, which, as depicted in FIG. 5, may run in the cloud (e.g., as part of a SaaS solution).

As previously described, a PPU is a highly efficient processing element that may receive a prompt as an input (e.g., from client application and/or an API 504), it may then identify the query carried in the prompt and detect and extract a set of key features from the query. For instance, primary PPU 505 may detect the class of tasks requested by a user in the prompt, the data needed to complete such tasks, any constraints applicable to perform the tasks requested, and/or the desired output upon completion of such tasks.

Moreover, primary PPU 505 may act as a transparent element, delivering the unmodified prompts (e.g., prompts 503) augmented with prompt and user metadata 506 that may carry specific features from prompts 503, such as those described above as well as user related metadata (e.g., the client or tenant ID, the user ID, and the client application ID). More specifically, primary PPU 505 may systematically distill and characterize prompts 503, thereby enabling new observability and insights as well as the enforcement of policy and controls downstream.

Once deployed, primary PPU 505 may need continuous evaluation to keep track of, and account for, possible misdetections and/or misclassifications during its operation. However, client 502 will typically not allow solution providers to store and subsequently use their prompts for future evaluation and/or training purposes. Hence, evaluation process 501 may be configured to enable such evaluation and the dynamic and selective collection of user feedback concurrently at inference time.

To this end, a confidence prediction element 507 may be included with a secondary PPU 508. In various implementations, both the primary PPU 505 and secondary PPU 508 may include classifiers operating in parallel. More specifically, a first classifier that might be executed by primary PPU 505, might operate independently, and therefore, be oblivious of a second classifier that might be executed by secondary PPU 508.

In this arrangement, the first classifier may be trained with a loss that penalizes when its predicted class A (e.g., A=“Content Processing”) is different from the Ground-Truth class G (e.g., G=“Data Analysis”), and therefore, the classification delivered by the first classifier (or PPU) is incorrect (i.e., A !=G). The second classifier may be trained on the same data set as the first classifier, or a separate data set with a similar distribution, but with a disagreement-promoting loss, more flexible than a regular classification loss in multi-class classification, that penalizes when the predicted class B, delivered by the second classifier, is such that B=A when A !=G, or B !=A when A=G.

Hence, the techniques introduced herein may target a relaxed multi-class classification learning model, where a second classifier does not attempt to predict the correct class G, but instead targets to predict a random class (e.g., ground-truth or not) that is different from the prediction of the first classifier when the prediction made by the first classifier is wrong. In contrast to techniques where classifiers are operating in tandem often cascading the input data (e.g., this is typically the case with various families of boosting-based learners), with the techniques described herein, the classifiers do not cascade the input data, but instead, they operate in parallel and only their loss functions are inherently cascaded.

As a result, confidence prediction element 507 may parse both the raw prompts sent by the users (i.e., prompts 503) along with the classifications made by primary PPU 505 and additional metadata (i.e., prompt and user metadata 506). Further, confidence prediction element 507 may provide means to assess and detect at inference time whether the likelihood of a correct prediction by primary PPU 505 is low (e.g., below a threshold).

The output 509 of confidence prediction element 507 may be used as an input to a classification feedback control element 510. Output 509 may comprise the evaluations made by confidence prediction element 507 along with additional metadata, including the prompt ID, the client or tenant ID, the user ID, the client application ID, and/or other elements that may enable classification feedback control element 510 to unequivocally identify the user and its context. Hence, in cases where the input received from confidence prediction element 507 indicate that the likelihood that primary PPU 505 classified a prompt correctly is low, classification feedback control element 510 may dynamically assess and decide whether feedback from the user might be required.

To this end, classification feedback control element 510 may connect to a selective response request element 511 using interface 512 and may use the user ID received from confidence prediction element 507 to index and retrieve the desired information. More specifically, the user metadata received by classification feedback control element 510 may be used as user metadata 514 in interface 512 to discover, populate, and subsequently index and retrieve data from entries in a response characterization database 513, which may be part of selective response request element 511 (e.g., the PPU-specific checks as detailed below and the output of selective response request element 511, which may be used as an input to classification feedback control element 510).

In various implementations, selective response request element 511 may be utilized to store the feedback selectively requested to, and the responses received from, the users. In addition, the selective response request element 511 may be utilized to learn, characterize, and/or dynamically select and adapt the request of feedback at inference time based on the history and trustworthiness of the responses received. Further, the selective response request element 511 may be utilized to compute and determine whether incentives should be applied or not to get feedback depending on such characterization.

Hence, when the likelihood that primary PPU 505 classified a prompt correctly is low (e.g., below a threshold) and selective response request element 511 indicates that feedback is required, classification feedback control element 510 may use one of the plugin models described above to send a system response 515 to client application and/or API 504. Collecting feedback when users utilize a chat interface or application that has predefined GUI integration with the system 500 described herein may be straightforward.

For instance, this could be the case when an assistant or chat interface has already an API and GUI integration (e.g., in the form of a pop-up element or button) that might be activated when the user's feedback is required. However, if the chat interface is part of a third-party application or assistant and the software development team that implemented such an application or assistant has no interest in adding this feature, then collecting feedback from the users may be a challenge.

Thus, upon detection of a “request feedback” condition, the classification feedback control element 510 may trigger a message back to the user directly in the assistant or chat application (e.g., in the form of a system response without requiring the implementation of additional thumbs up buttons, pop-up elements, or other means to provide such feedback at GUI level). Differently from messages available to the user as part of standard completions (e.g., the responses sent by an LLM), an unsolicited message in the form of system response 515 may be generated by classification feedback control element 510, and the user's response to such messages, response 516, may be intercepted again and processed by classification feedback control element 510 without the language model (e.g., LLM) intervention.

For instance, system response 515 may be templated and may indicate that feedback is required from the user. It may ask the user whether the user agrees with the classification made by primary PPU 505, and it may also list a set of categories that the user may choose from in case of disagreement. Such functionality may be enabled by the same plugin 517 utilized to intercept or collect prompts 503, that is, through the plugin supporting the communications with primary PPU 505 and/or other elements that the PPU may be part of (e.g., elements within evaluation process 501).

The feedback received from the user, response 516, might be processed by classification feedback control element 510, and stored in response characterization database 513 using interface 512. Such feedback may now be used as part of the continuous characterization running in selective response request element 511 with the objective of selectively deciding when such feedback would be desired, thereby reducing user fatigue.

Indeed, selective response request element 511 may store and analyze the feedback received by the various users in the system (not claimed, prior art techniques may be used to this end). Further, selective response request element 511 may perform quality control mechanisms at inference time. This may include random consistency checks to assess whether the feedback supplied by users is consistent with previously known data or annotations. For instance, classification feedback control element 510 may request user feedback for queries for which the likelihood of primary PPU 505 delivering the correct classification is very high, or cases in which the ground-truth is known in advance (e.g., when templated prompts that have been part of the training data set are used).

In various implementations, system response 515 messages might be independent of the previous prompt (query) sent by the user, and they may carry user feedback requests in real time with known answers (e.g., gold standard) to test the user reliability. In additional implementations, classification feedback control element 510 may randomly test the user by deliberately presenting a classification that is known to be incorrect in system response 515 (e.g., classification feedback control element 510 may know that the correct classification was “brainstorming”, while system response 515 indicates that the classification was “content creation”). These techniques may be used to assess the trustworthiness of the responses received and keep track of users with a history of providing reliable feedback.

Selective response request element 511 may also detect inconsistent feedback, which may indicate lack of interest in providing such feedback, or worse, the aim of a user to intentionally provide misinformation. This may encompass techniques to detect adversarial behavior, where users might deliberately provide wrong feedback to mislead the system.

In addition, selective response request element 511 may assess and characterize the trustworthiness of the feedback history on a per user basis. In various implementations, selective response request element 511 may assess and decide whether incentives might be applied for collecting feedback from reliable users. For instance, the quota of tokens that might be used across system 500 may be dynamically increased for collaborative or reliable users, or such increases may be prevented for less collaborative users, or adversarial users or users that tried to abuse the system and obtain the incentives without actually providing useful feedback may even be backlisted.

Selective response request element 511 may dynamically adjust and selectively decide whether the solicitation of feedback and potential incentives may apply based on a set of elements. For example, the dynamic adjustment and/or selective decision may be based on two main elements such as: i) the characterization above described; and ii) the volume of feedback that has already been solicited to a user. More specifically, the volume of previous feedback requested to a user over a given period of time may operate as a de-amplifying factor, thereby reducing the users' fatigue.

The output 518 of classification feedback control element 510 may be forwarded to a continuous PPU evaluation element 519 and stored in PPU metadata database 520. In one embodiment, the output of primary PPU 505 might even be relabeled by classification feedback control element 510, hence delivering a final classification considering both the output 521 of confidence prediction element 507 and the feedback selectively received from users.

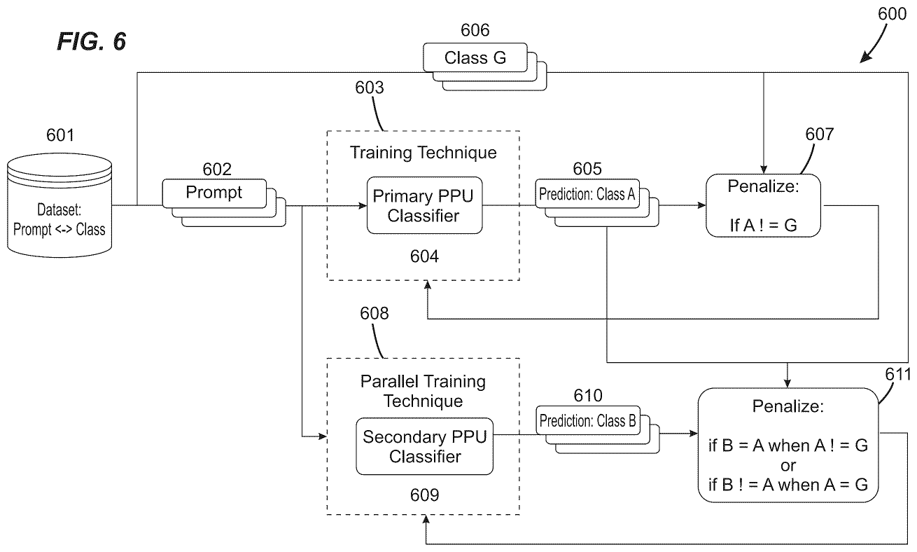

FIG. 6 illustrates an example of system 600 that may be used for training both a primary PPU classifier 604, and a secondary PPU classifier 609, concurrently, on the same training data set 601. A pool of prompts (e.g., prompts 602) from training data set 601 may be used for training primary PPU classifier 604 using training technique 603.

For each prompt, primary PPU classifier 604 may deliver one or more predictions (e.g., predictions 605) (e.g., the class of task detected might be class A). As described above, primary PPU classifier 604 might be trained with a loss 607 that penalizes when the predicted class A is different from the Ground-Truth class G 606, that is, when A !=G. Note that the primary PPU classifier 604 may have been trained a priori, potentially on a different dataset, in which case the training technique 603 may be deactivated and prompts 602 may only pass through primary PPU classifier 604 in inference mode to obtain predictions 605, without any training.

Likewise, prompts 602 from training data set 601 may also be used for training secondary PPU classifier 609 using a parallel training technique 608. For each prompt, secondary PPU classifier 609 may deliver one or more predictions (e.g., predictions 610) (e.g., the class of task detected might be class B). In this case, and as described above, secondary PPU classifier 609 might be trained with a loss 611 that penalizes when the predicted class B fulfills either one of the following conditions; condition 1: B=A when A !=G or condition 2: B !=A when A=G.

It's worth noting that, loss 611 may be more loose than regular training losses in multi-class classification settings, by enabling secondary PPU classifier 609 to focus on producing disagreements, rather than focusing on the harder case of predicting the correct class when primary PPU classifier 604 makes a wrong prediction.

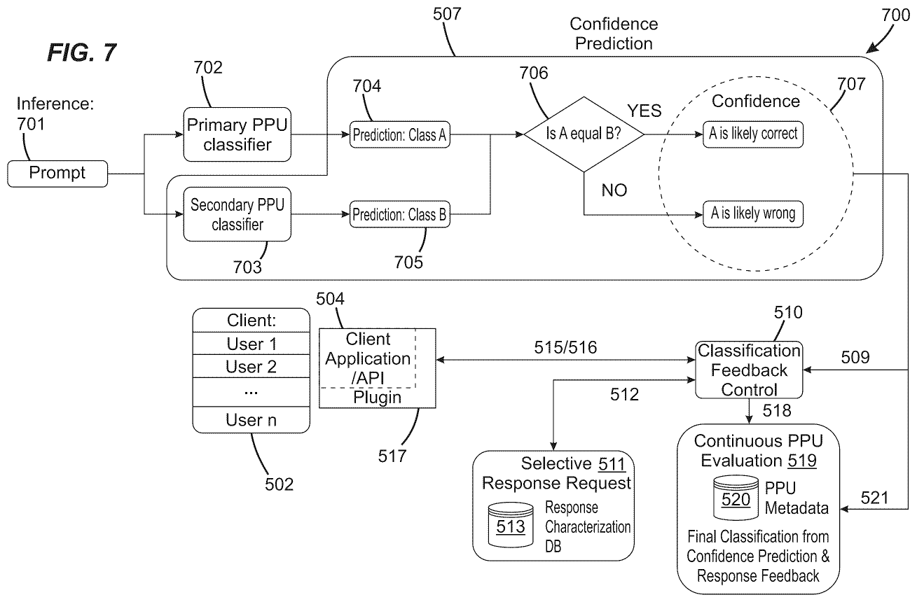

FIG. 7 illustrates an example of a system 700 for implementing a confidence prediction procedure at inference time. Here, prompt 701 may be concurrently processed both by primary PPU classifier 702, and secondary PPU classifier 703. These classifiers may deliver predicted classes (e.g., predicted class 704 and predicted class 705, respectively).

Secondary PPU classifier 703 as well as predicted class 704 and predicted class 705 may be used by confidence prediction element 507, which may check, at 706, for disagreements between the classifications delivered by primary PPU classifier 702 and secondary PPU classifier 703. Based on this, a confidence process 707 may compute the likelihood that primary PPU classifier 702 made a correct classification. In cases where such likelihood is low, confidence prediction element 507 may trigger the analysis and potential feedback request via classification feedback control element 510, as detailed above.

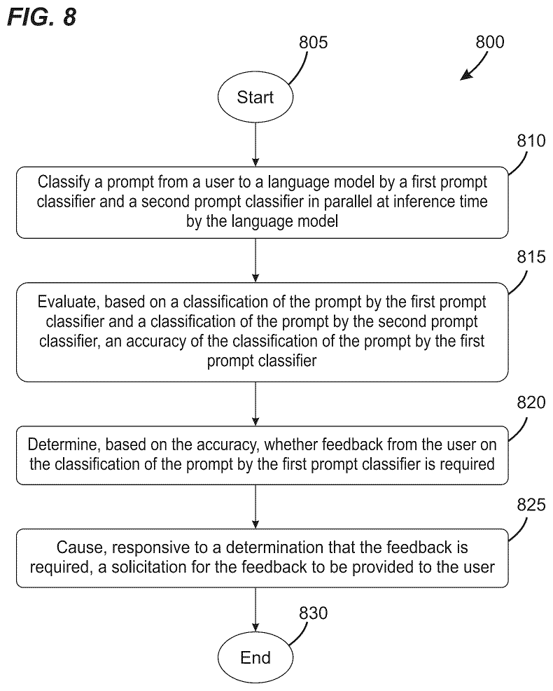

FIG. 8 illustrates an example of a simplified procedure for accuracy evaluation and selective feedback control for prompt processing units at inference time, in accordance with one or more implementations described herein. For example, a non-generic, specifically configured device (e.g., device 200), may perform procedure 800 (e.g., a method) by executing stored instructions (e.g., evaluation process 248).

The procedure 800 may start at step 805, and continues to step 810, where, as described in greater detail above, the device (e.g., a controller, processor, etc.) may classify a prompt from a user to a language model by a first prompt classifier and a second prompt classifier in parallel at inference time by the language model. The first and/or second prompt classifiers may be prompt processing units that may be configured to an obtain an input (e.g., from client application and/or an API), automatically identify the query carried in the prompt, and detect and extract a set of key features from the query. For instance, the PPUs may detect the class of tasks requested by a user in the prompt, the data needed to complete such tasks, any constraints applicable to perform the tasks requested, and/or the desired output upon completion of such tasks. As such, the classification of the prompt by the first prompt classifier may identify the features of the prompt indicative of one or more of a task requested in the prompt, a constraint applicable to completing the task, or data needed to complete the task.

The first prompt classifier may include a model trained with a loss function that penalizes when a predicted class from the first prompt classifier is different from a ground truth class. Meanwhile, the second prompt classifier may include a model trained with a different loss function that promotes disagreement between a predicted class from the second prompt classifier and a predicted class from the first prompt classifier when it is different from a ground truth class.

At step 815, as detailed above, a device may evaluate an accuracy of the classification of the prompt by the first prompt classifier. The evaluation of the accuracy may be based on based on a classification of the prompt by the first prompt classifier and a classification of the prompt by the second prompt classifier. For example, the accuracy of the classification of the prompt by the first prompt classifier may be determined based on whether there is agreement between the classification of the prompt by the first prompt classifier and the classification of the prompt by the second prompt classifier.

At step 820, as detailed above, a device may determine, based on the accuracy, whether feedback from the user on the classification of the prompt by the first prompt classifier is required. For example, when the likelihood that a classification from a primary PPU has classified a prompt correctly is low (e.g., there is disagreement with a classification by a secondary PPU, etc.) this may serve as an indication that feedback is required and/or that one of the plugin models described above should be used to send a system response (e.g., including a solicitation for feedback) to client application and/or API.

At step 825, as detailed above, the device may cause a solicitation for the feedback to be provided to the user responsive to a determination that the feedback is required. The feedback received from the user in response to the solicitation may be intercepted and/or logged without intervention by the language model.

In various implementations, quality control checks may be performed on the feedback received from the user in response to the solicitation. Quality control checks may be performed at inference time and may include random consistency checks to assess whether the feedback supplied by users is consistent with previously known data or annotations (e.g., request user feedback for queries for which the likelihood of a primary PPU delivering the correct classification is very high, or cases in which the ground-truth is known in advance such as when templated prompts that have been part of the training data set are used, system response messages may carry user feedback requests in real time with known answers to test the user reliability, randomly test the user by deliberately presenting a classification that is known to be incorrect in system response, etc.).

Further, attributes of feedback received from the user in response to solicitations may be identified (e.g., by the quality control checks, via other assessments, etc.) and/or logged. These attributes may include the identification of inconsistent feedback, intentional misinformation, adversarial behavior, trustworthiness of the feedback, accuracy of feedback, etc.

The solicitation for the feedback may be adapted (e.g., selected, modified, incentivized, etc.) based on attributes of prior feedback received from the user. For example, incentives may be offered to the user to provide the feedback based on a reliability of prior feedback received from the user.

In some instances, a determination may be made as to whether feedback from the user on the classification of the prompt by the first prompt classifier is required based on a volume of previous feedback requests to the user. For example, the volume of previous feedback requested to a user over a given period of time may operate as a de-amplifying factor, thereby reducing the users' fatigue.

Procedure 800 then ends at step 830.

It should be noted that while certain steps within procedure 800 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a technique that facilitates continuous evaluation of the accuracy of the detections and classifications performed by a prompt processing unit (PPU) directly at inference time. The techniques provide a confidence prediction mechanism coupled with an adaptive response and incentive method designed to selectively request and collect user feedback. The feedback received at inference time may even be used to override the original detection made by a PPU. These techniques may be applied concurrently at inference time, thereby requiring neither the storage of user prompts nor their subsequent processing.

This approach to dynamically classifying and evaluating prompts in parallel at inference time using multiple PPUs provides a flexible and adaptive framework for prompt classification. For instance, the reliability of classifications in environments requiring real-time decision making may be enhanced by leveraging diverse perspectives on an input. This layered parallel structure ensures that prompt classifications are both robust and contextually aware, allowing for better handling of ambiguities and reducing the risk of misclassifications. Further, this architecture can be applied across various enterprise systems, improving everything from data controls to fine-tuning user query responses in natural language processing frameworks. These techniques ensure that prompt processing systems can dynamically adapt to various classification challenges, delivering more reliable results without compromising efficiency.

Further, the techniques introduce an intelligent feedback collection and incentivization approach. This approach can intelligently identify when user feedback on a classification may be useful and selectively apply incentives where it is most likely to produce the best feedback and/or user experience. This system can enhance the overall quality of classification feedback and ensure that the feedback is collected more efficiently, with minimal user fatigue and greater trust in the integrity of the classification process. This approach further optimizes the feedback loop, contributing to more accurate and reliable classification outcomes without excessive reliance on inconsistent or unreliable feedback sources.

While there have been shown and described illustrative implementations that provide for accuracy evaluation and selective feedback control for prompt processing units at inference time, it is to be understood that various other adaptations and modifications may be made within the spirit and scope of the implementations herein. For example, while certain implementations are described herein with respect to using certain elements, modules, components, architectures, etc. for the purposes of accuracy evaluation and selective feedback control for prompt processing units at inference time, the elements, modules, components, architectures, etc., are not limited as such and may be used for other functions, in other arrangements, in other functional distributions, in other implementations, etc. In addition, while certain types of metadata and data types/categories such as tasks, sensitive data, constraints, and outputs are shown, other suitable metadata and data types/categories may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having computer-readable instructions stored thereon that, when executed by a processor on device, cause the device to perform a method in accordance with the teachings herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
classifying, by a device, a prompt from a user to a language model by a first prompt classifier and a second prompt classifier in parallel at inference time by the language model;
evaluating, by the device and based on a classification of the prompt by the first prompt classifier and a classification of the prompt by the second prompt classifier, an accuracy of the classification of the prompt by the first prompt classifier;
determining, by the device and based on the accuracy, whether feedback from the user on the classification of the prompt by the first prompt classifier is required; and
causing, by the device and responsive to a determination that the feedback is required, a solicitation for the feedback to be provided to the user.

2. The method of claim 1, further comprising:
performing quality control checks on feedback received from the user in response to the solicitation.

3. The method of claim 1, further comprising:
adapting the solicitation for the feedback based on attributes of prior feedback received from the user.

4. The method of claim 1, further comprising:
providing incentives to the user to provide the feedback based on a reliability of prior feedback received from the user.

5. The method of claim 1, further comprising:
determining whether feedback from the user on the classification of the prompt by the first prompt classifier is required additionally based on a volume of previous feedback requests to the user.

6. The method of claim 1, wherein the first prompt classifier includes a model trained with a loss function that penalizes when a predicted class from the first prompt classifier is different from a ground truth class.

7. The method of claim 6, wherein the second prompt classifier includes a model trained with a different loss function that promotes disagreement between a predicted class from the second prompt classifier and a predicted class from the first prompt classifier when it is different from the ground truth class.

8. The method of claim 1, further comprising:
determining the accuracy of the classification of the prompt by the first prompt classifier based on whether there is agreement between the classification of the prompt by the first prompt classifier and the classification of the prompt by the second prompt classifier.

9. The method of claim 1, further comprising:
intercepting feedback received from the user in response to the solicitation without intervention by the language model.

10. The method of claim 1, wherein the classification of the prompt by the first prompt classifier identifies features of the prompt indicative of one or more of a task requested in the prompt, a constraint applicable to completing the task, or data needed to complete the task.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
classify a prompt from a user to a language model by a first prompt classifier and a second prompt classifier in parallel at inference time by the language model;
evaluate, based on a classification of the prompt by the first prompt classifier and a classification of the prompt by the second prompt classifier, an accuracy of the classification of the prompt by the first prompt classifier;
determine, based on the accuracy, whether feedback from the user on the classification of the prompt by the first prompt classifier is required; and
cause, and responsive to a determination that the feedback is required, a solicitation for the feedback to be provided to the user.

12. The apparatus as in claim 11, the process further configured to:
perform quality control checks on feedback received from the user in response to the solicitation.

13. The apparatus as in claim 11, the process further configured to:
adapt the solicitation for the feedback based on attributes of prior feedback received from the user.

14. The apparatus as in claim 11, the process further configured to:
provide incentives to the user to provide the feedback based on a reliability of prior feedback received from the user.

15. The apparatus as in claim 11, the process further configured to:
determine whether feedback from the user on the classification of the prompt by the first prompt classifier is required additionally based on a volume of previous feedback requests to the user.

16. The apparatus as in claim 11, wherein the first prompt classifier includes a model trained with a loss function that penalizes when a predicted class from the first prompt classifier is different from a ground truth class.

17. The apparatus as in claim 16, wherein the second prompt classifier includes a model trained with a different loss function that promotes disagreement between a predicted class from the second prompt classifier and a predicted class from the first prompt classifier when it is different from the ground truth class.

18. The apparatus as in claim 11, the process further configured to:
determine the accuracy of the classification of the prompt by the first prompt classifier based on whether there is agreement between the classification of the prompt by the first prompt classifier and the classification of the prompt by the second prompt classifier.

19. The apparatus as in claim 11, the process further configured to:
intercept feedback received from the user in response to the solicitation without intervention by the language model.

20. A tangible, non-transitory, computer-readable medium having computer-executable instructions stored thereon that, when executed by a device, cause the device to perform a method comprising:
classifying a prompt from a user to a language model by a first prompt classifier and a second prompt classifier in parallel at inference time by the language model;
evaluating, based on a classification of the prompt by the first prompt classifier and a classification of the prompt by the second prompt classifier, an accuracy of the classification of the prompt by the first prompt classifier;
determining, based on the accuracy, whether feedback from the user on the classification of the prompt by the first prompt classifier is required; and
causing, responsive to a determination that the feedback is required, a solicitation for the feedback to be provided to the user.
